(19) United States
(12) Patent Application Publication
(10) Pub. No.: US 2024/0140239 A1
(43) Pub. Date: May 2, 2024

(54) MANAGEMENT OF VEHICLE-RELATED SERVICES BASED ON DEMAND AND PROFITABILITY

(71) Applicant: Honda Motor Co., Ltd., Tokyo (JP)

(72) Inventor: GEETHANJALI ANAND, Chicago, IL (US)

(21) Appl. No.: 17/978,786

(22) Filed: Nov. 1, 2022

(51) Int. Cl. B60L 53/62; B60L 58/12

(52) U.S. Cl. CPC B60L 53/62; B60L 58/12

(57) ABSTRACT

An electronic device and method for management of vehicle-related services based on demand and profitability is provided. The electronic device receives from a service provider associated with a charging station, an input that includes a threshold selling price for a vehicle charging service. The electronic device collects information that includes requests for the vehicle charging service from electric vehicles and estimates a demand for the vehicle charging service based on the information. The electronic device determines a selling price for the vehicle charging service based on the demand and updates a list of active charging stations that includes the charging station associated with the service provider. The update is performed based on a comparison of the selling price with the threshold selling price. Based on the updated list of active charging stations, the electronic device controls a rendering of a map-based user interface on display devices.

### BACKGROUND

Advancements in electric vehicle (EV) technology have led to wider adoption of battery electric vehicles (BEVs). One of the key concerns of many BEV users is limited availability of charging infrastructure. To address the concern, many individuals especially homeowners, as service providers, may open up new charging stations or may commercialize their existing charging stations to offer a charging service to individual BEV users in return for a fee. Within a region, there may be multiple such stations that BEV users may use for charging the BEVs. If there are too many charging stations in the region, then the demand may dry up and the cost of charging may go down (i.e., the fee may go down). In the region, this may affect revenue and profitability of many of the service providers, which may be contrary to the intention for opening up or commercializing the charging stations.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic device to manage vehicle-related services based on demand and profitability is provided. The electronic device may include a memory that stores a list of active charging stations circuitry that may receive an input from a service provider associated with a charging station. The input may include a threshold selling price for a vehicle charging service. The circuitry may collect information that includes requests for the vehicle charging service from a set of electric vehicles. Based on the collected information, the circuitry may estimate a demand for the vehicle charging service in a geographical region. The list of active charging stations may correspond to a plurality of charging stations that may operate in the geographical region. The plurality of charging stations may include the charging station associated with the service provider. The circuitry may determine a selling price for the vehicle charging service based on the estimated demand. The determined selling price may be compared with the threshold selling price for the vehicle charging service. The circuitry may update the list of active charging stations based on the comparison of the determined selling price with the threshold selling price. Based on the updated list of active charging stations, the circuitry may control rendering of a map-based User Interface (UI) for the vehicle charging service on one or more display devices.

According to another embodiment of the disclosure, a method for managing vehicle-related services based on demand and profitability is provided. The method may include storing a list of active charging stations in memory and receiving an input that includes a threshold selling price for a vehicle charging service from a service provider associated with a charging station. The method may further include collecting information that includes requests for the vehicle charging service from a set of electric vehicles and estimating a demand for the vehicle charging service in a geographical region based on the collected information. The list of active charging stations may correspond to a plurality of charging stations that may operate in the geographical region. The plurality of charging stations may include the charging station associated with the service provider. The method may further include determining a selling price for the vehicle charging service based on the demand and updating the list of active charging stations based on a comparison of the determined selling price with the threshold selling price. The method may further include controlling a rendering of a map-based UI for the vehicle charging service on one or more display devices. The rendering may be controlled based on the updated list of active charging stations.

According to another embodiment of the disclosure, a non-transitory computer-readable medium is provided. The non-transitory computer-readable medium may have stored thereon computer-implemented instructions that, when executed by an electronic device, causes the electronic device to execute operations. The operations may include receiving from a service provider associated with a charging station, an input that includes a threshold selling price for a vehicle charging service. The operations may further include collecting information that includes requests for the vehicle charging service from a set of electric vehicles and estimating a demand for the vehicle charging service in a geographical region based on the collected information. The list of active charging stations may correspond to a plurality of charging stations that operate in the geographical region. The plurality of charging stations may include the charging station associated with the service provider. The operations may further include determining a selling price for the vehicle charging service based on the demand and updating the list of active charging stations based on a comparison of the determined selling price with the threshold selling price. The operations may further include controlling a rendering of a map-based UI for the vehicle charging service on one or more display devices. The rendering may be controlled based on the updated list of active charging stations.

### BRIEF DESCRIPTION OF THE DRAWINGS

FIG. 1 is a block diagram that illustrates an exemplary network environment for management of vehicle-related services based on demand and profitability, in accordance with an embodiment of the disclosure.

FIG. 2 is a block diagram that illustrates an exemplary electronic device that serves as a platform for management of vehicle-related services based on demand and profitability, in accordance with an embodiment of the disclosure.

FIG. 3 is an exemplary scenario diagram that illustrates reception of a set of inputs that includes a threshold selling price for offering of a vehicle charging service, in accordance with an embodiment of the disclosure.

FIG. 4A is an exemplary scenario diagram that illustrates determination of a selling price for a vehicle charging service based on a demand for the vehicle charging service, in accordance with an embodiment of the disclosure.

FIG. 4B is an exemplary scenario diagram that illustrates determination of a selling price for a vehicle charging service based on a demand for the vehicle charging service, in accordance with an embodiment of the disclosure.

FIG. 5A is an exemplary scenario diagram that illustrates updating of a list of active charging stations based on a selling price for a vehicle charging service and a threshold selling price, in accordance with an embodiment of the disclosure.

FIG. 5B is an exemplary scenario diagram that illustrates rendering of an option to update a list of active charging stations, in accordance with an embodiment of the disclosure.

FIG. 6 is an exemplary scenario diagram that illustrates rendering of a map-based user interface for a vehicle charging service on a display device, in accordance with an embodiment of the disclosure.

FIG. 7 is a flowchart that illustrates exemplary operations for management of vehicle-related services based on demand and profitability via a platform in an electronic device, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed electronic device and method for management of vehicle-related services based on demand and profitability. Exemplary aspects of the disclosure may provide an electronic device (such as a desktop, a laptop, or a mobile phone) that may be configured to store a list of active (or operational) charging stations. The electronic device receives from a service provider (included in the electronic device) associated with a charging station, an input that includes a threshold selling price for a vehicle charging service (to be provided by the charging station). The electronic device may collect information that includes requests for the vehicle charging service from a set of electric vehicles and may estimate a demand for the vehicle charging service in a geographical region based on the collected information. The list of active charging stations may correspond to a plurality of charging stations that may operate in the geographical region. The plurality of charging stations may include the charging station associated with the service provider. The electronic device may determine a selling price for the vehicle charging service based on the demand. The electronic device may update the list of active charging stations based on a comparison of the determined selling price with the threshold selling price. The electronic device may control, based on the updated list of active charging stations, rendering of a map-based User Interface (UI) for the vehicle charging service on one or more display devices (for example, a display of a mobile phone).

In order to offer a charging service to individual BEV customers for a fee, many people, especially homeowners, may open up new charging stations or monetize their current charging stations. Multiple such stations may exist in a given area for BEV customers to use in order to charge their vehicles. Service providers (i.e., owners or operators) of charging stations may desire to maintain a competitive selling price for the charging service in the area while remaining profitable inside a market that is competitive. In a competitive market, the prices may typically vary based on a number of charging stations that operate at any given time in a geographical region. For instance, if there are many operational charging stations in the region, the prices may decrease and the demand for the vehicle charging service may dry up for some of the charging stations. A lower demand may affect the profitability of such stations. This may have an adverse effect on the revenue and profitability of numerous service providers in the area, which may be against the purpose of establishing or monetizing the charging stations.

In order to address this issue, the disclosed electronic device may automatically pull a charging station out of a list of active charging stations in a geographical regions if it is determined that the selling price for the vehicle charging service across the charging stations has reached a value that is below a threshold value (set by a service provider for a particular charging station). In other words, if the number of charging stations in the region causes the selling price (e.g., charges in USD) to be less than service provider's expectation, the charging station may disappear from a map-based UI. This may cause other charging stations to increase the selling price, which eventually improves the profitability. In some instances, the active charging stations may communicate between each other to keep the selling price above a certain threshold price. For example, the charging stations may shut off their services depending on respective price thresholds. This may be geography-specific to ensure that there are enough charging stations to cater to charging requirements of vehicles in the region.

Reference will now be made in detail to specific aspects or features, examples of which are illustrated in the accompanying drawings. Wherever possible, corresponding, or similar reference numbers will be used throughout the drawings to refer to the same or corresponding parts.

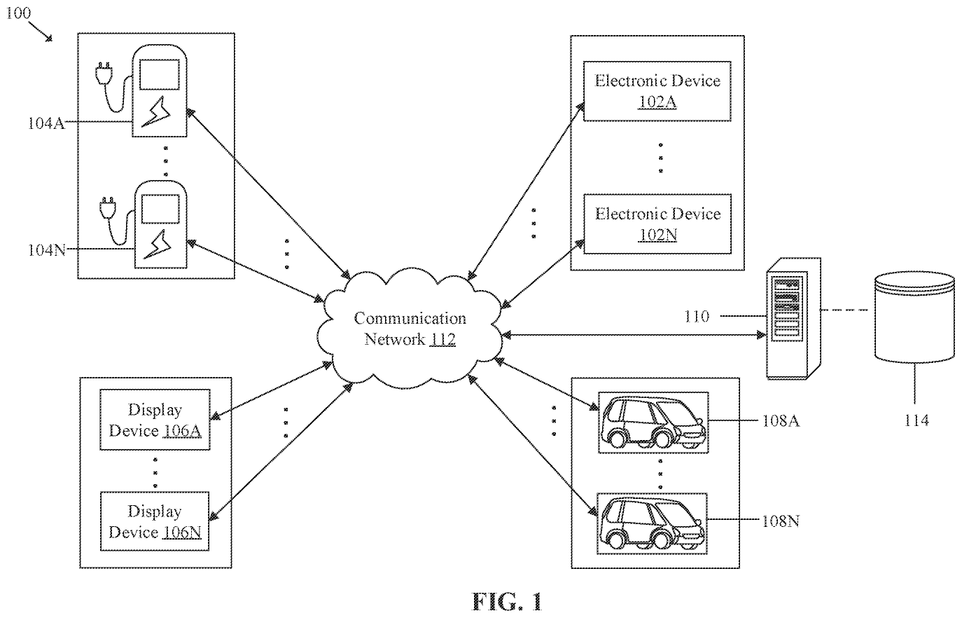

FIG. 1 is a block diagram that illustrates an exemplary network environment for management of vehicle-related services based on demand and profitability, in accordance with an embodiment of the disclosure. With reference to FIG. 1, there is shown a network environment 100. The network environment 100 may include a set of electronic devices 102A . . . 102N, a set of charging stations 104A . . . 104N, a set of display devices 106A . . . 106N, a set of electric vehicles 108A . . . 108N, and a server 110. Each electronic device (for example, the electronic device 102A) may be configured to communicate with other electronic devices (for example, the electronic device 102N) of the set of electronic devices 102A . . . 102N, the set of charging stations 104A . . . 104N, the set of display devices 106A . . . 106N, the set of electric vehicles 108A . . . 108N, and the server 110, through a communication network 112. The set of electronic devices 102A . . . 102N may include an electronic device 102A, . . . , and an electronic device 102N. The set of charging stations 104A . . . 104N may include a charging station 104A, . . . , and a charging station 104N. The set of display devices 106A . . . 106N may include a display device 106A, . . . , and a display device 106N. The set of electric vehicles 108A . . . 108N may include an electric vehicle 108A, . . . , and an electric vehicle 108N. The server 110 may store a database 114.

Each electronic device of the set of electronic devices 102A . . . 102N may be associated with a charging station of the set of charging stations 104A . . . 104N. For example, the electronic device 102A may be associated with the charging station 104A. Similarly, the electronic device 102N may be associated with the charging station 104N. Each display device of the set of display devices 106A . . . 106N may be associated with an electric vehicle of the set of electric vehicles 108A . . . 108N. For example, the display device 106A may be associated with the electric vehicle 108A. Similarly, the display device 106N may be associated with the electric vehicle 108N.

Each electronic device of the set of electronic devices 102A . . . 102N may include suitable logic, circuitry, interfaces, and/or code that may be configured to manage vehicle-related services (for example, a vehicle charging service) based on a demand for the vehicle charging service and a profitability associated with such services. The electronic device 102A may estimate the demand based on one or more requests received from one or more vehicles of the set of electric vehicles 108A . . . 108N for the vehicle charging service. The electronic device 102A may determine the profitability based on the estimated demand and a threshold selling price (e.g., a price set by a service provider) for the vehicle charging service. Example implementations the electronic device may include, but are not limited to, a computing device, a desktop, a personal computer, a laptop, a computer workstation, a tablet computing device, a smartphone, a cellular phone, a mobile phone, or a consumer electronic (CE) device having a display.

Each charging station of the set of charging stations 104A . . . 104N may include suitable logic, circuitry, interfaces, and/or code that may be configured to offer vehicle charging service to the set of electric vehicles 108A . . . 108N. Each charging station may include one or more charging connectors. Each charging connector may be compatible with a charging port of a vehicle and may have capability to provide services such as Direct Current (DC) fast charging, DC (normal) charging, Alternating Current (AC) fast charging, or AC (normal) charging. Each charging station of the set of charging stations 104A . . . 104N may include a cable and a connector at the end of the cable. At the charging spot of a charging station (for example, the charging station 104A), the charging connector may be configured to engage with a charging port of an electric vehicle (for example, the electric vehicle 108A) to enable a transfer of electric power from the charging station 104A to a battery pack of the electric vehicle 108A.

Each charging station may include a network interface that may be configured to facilitate communication between the charging station and an electronic device of the set of electronic devices 102A . . . 102N via the communication network 112. The network interface for a charging station may be used to transmit information associated with the charging station such as a count of charging spots at the charging station, type of charging services offered by the charging station, availability (or occupancy) of charging spots, and so on. For example, the charging station 104A may transmit information associated with the count of charging spots of the charging station 104A, a number of charging spots that are in use, a capability of the charging station 104A to provide DC fast charging and/or AC charging, and so on. The information may be transmitted to the electronic device 102A if the electronic device 102A is associated with the charging station 104A. The electronic device 102A may transmit the received information to the other electronic devices of the set of electronic devices 102A . . . 102N. Similarly, the electronic device 102A may receive information associated with other charging stations 104B . . . 104N (i.e., stations different from the charging station 104A) from other electronic devices 102B . . . 102N.

Each display device of the set of display devices 106A . . . 106N (for example, the display device 106A) may include suitable logic, circuitry, interfaces, and/or code that may be configured to render a map-based User Interface (UI) for the vehicle charging service. The map-based UI may be associated with a map-based application that may be included in or may be accessible via a web client on the set of display devices 106A . . . 106N. In accordance with an embodiment, electronic device 102A may control at least one of the set of the display devices 106A . . . 106N to render the map-based UI. The rendered map-based UI may include UI elements to represent the set of charging stations 104A . . . 104N that may be active (i.e., i.e., actively offering the vehicle charging service) in a geographical region.

Each display device (for example, the display device 106A) of the set of display devices 106A . . . 106N may include a network interface that may be configured to facilitate communication between an electronic device of the set of electronic devices 102A . . . 102N and an electric vehicle of the set of electric vehicles 108A . . . 108N. The display device 106A may transmit, via the network interface, a request to an electronic device (for example, the electronic device 102A associated with a service provider) to book or view charging slots available at any station of the set of charging stations 104A . . . 104N. The request may be transmitted on behalf of an electric vehicle (for example, the electric vehicle 108A) that may need the service at a future time instant (e.g., in next 30 mins). The display device 106A may transmit the request based on association of the display device 106A with the electric vehicle 108A. In accordance with an embodiment, the transmission of the request may be based on a current State of Charge (SOC) level of a battery pack of the electric vehicle 108A (received from the electric vehicle 108A via the network interface), a geo-location of the charging station 104A (associated with the electronic device 102A), and a geo-location of the electric vehicle 108A. The display device 106A may further transmit to the electronic device 102A information about the charging port that may be included in the electric vehicle 108A for plug-in charging. Example implementations of the display device may include, but are not limited to, an in-vehicle display, a tablet, a smartphone, a mobile phone, a CE device having a display, an Augmented Reality (AR) headset, an eXtended Reality (XR) headset, a Virtual Reality (VR) headset, an Internet of Things (IoT) device, smart glasses, an AR goggle, a VR goggle, a wearable display, or a head mounted display.

Each electric vehicles of the set of electric vehicles 108A . . . 108N may be a non-autonomous vehicle, a semi-autonomous vehicle, or a fully autonomous vehicle. Examples of an electric vehicle of the set of electric vehicles 108A . . . 108N may include, but are not limited to, a e-kick scooter, a personal transporter, an electric scooter, an electric unicycle, an electric bicycle, an electric hover board, an electric skateboard, a roller skate, a compact four-wheeler vehicle, a compact three-wheeler vehicle, a two-wheeler vehicle, a wheelchair with an actuator-based driving unit, a hybrid vehicle, or an electric vehicle with autonomous drive capability that uses one or more distinct renewable or non-renewable power sources. Examples of the compact four-wheeler vehicle may include, but are not limited to, an electric car or a hybrid car. Similarly, examples of the two-wheeler vehicle may include, but are not limited to, an electric two-wheeler or a hybrid two-wheeler.

The electric vehicle may include suitable logic, circuitry, and interfaces that may be configured to monitor the SOC of a battery pack of the vehicle. The electric vehicle may include an interface to communicate with a display device. In accordance with an embodiment, the electric vehicle may periodically transmit the SOC to the display device. Each electric vehicle may include a charging port that is compatible with a charging connector of at least one charging station of the set of charging stations 104A . . . 104N. The electric vehicle may further transmit information about the charging port of the electric vehicle to a display device of the set of display devices 106A . . . 106N that corresponds to the electric vehicle. The electric vehicle may include a location sensor to determine a current geolocation of the vehicle.

In accordance with an embodiment, the display device (for example, the display device 106A) associated with the electric vehicle may request a charging station (for example, a charging station 104A) for the vehicle charging service. The request may be based on a location of the charging station 104A (received from the electronic device 102A) and the location of the electric vehicle 108A (received from the electric vehicle 108A). Examples of the location sensor may include, but are not limited to, a Global Navigation Satellite System (GNSS)-based sensor. In accordance with an embodiment, each vehicle of the set of electric vehicles 108A . . . 108N may be connected to one or more wireless networks that provide information related to the current geo-location of the corresponding vehicle. For example, the wireless network may be a cellular-V2X (Vehicle-to-Everything) network, or a network based on DSRC (Dedicated short-range communication) protocol.

Each electric vehicle may include a battery unit which may be a source of electric power for one or more electric circuits or electric loads of the vehicle. The battery unit may be recharged by connecting the battery unit to a connector at a charging station. The battery unit may correspond to a battery pack, which may have a plurality of clusters of batteries surrounded by a suitable coolant system and a charge controller. Examples of the battery unit may include, but are not limited to, a lead acid battery, a nickel cadmium battery, a nickel-metal hydride battery, a lithium-ion battery, and other rechargeable batteries.

The server 110 may include suitable logic, circuitry, interfaces, and/or code that may be configured to receive information that includes requests for the vehicle charging service from the set of vehicles 108A . . . 108N, information associated with each of the set of charging stations 104A . . . 104N, a demand for the vehicle charging service, and a selling price for the vehicle charging service. The server 110 may generate time-series data that indicates values of a set of parameters (at regular time instants or corresponding to instances of demand estimation for the vehicle charging service), the estimated demand, and the selling price. The server 110 may transmit the received information and the generated time-series data to the set of electronic devices 102A . . . 102N based on reception of requests from the set of electronic devices 102A . . . 102N. The server 110 may store the received information and the generated time-series data in the database 114. In some embodiments, the server 110 may estimate the demand for the vehicle charging service and determine the selling price for the vehicle charging service. The server 110 may further receive a threshold selling price for the vehicle charging service and may update a list of active charging stations (i.e., the set of charging stations 104A . . . 104N) based on a comparison of the determined selling price and the threshold selling price. The server 110 may control the set of display devices 106A . . . 106N to render the updated list of active charging stations.

The server 110 may execute operations through web applications, cloud applications, Hypertext Transfer Protocol (HTTP) requests, repository operations, file transfer, and the like. Example implementations of the server 110 may include, but are not limited to, a database server, a file server, a web server, an application server, a mainframe server, a cloud computing server, or a combination thereof.

In at least one embodiment, the server 110 may be implemented as a plurality of distributed cloud-based resources by use of several technologies that are well known to those ordinarily skilled in the art. A person with ordinary skill in the art will understand that the scope of the disclosure may not be limited to the implementation of the server 110 and the set of electronic devices 102A . . . 102N as separate entities. In certain embodiments, the functionalities of the server 110 may be incorporated in its entirety or at least partially in at least one electronic device of the set of electronic devices 102A . . . 102N, without a departure from the scope of the disclosure.

The communication network 112 may correspond to a communication medium through which each of the set of electronic devices 102A . . . 102N, each of the set of charging stations 104A . . . 104N, each of the set of display devices 106A . . . 106N, each of the set of electric vehicles 108A . . . 108N, and the server 110, and may communicate with each other. The communication network 112 may be one of a wired connection or a wireless connection. Examples of the communication network 112 may include, but are not limited to, the Internet, a cloud network, a Cellular or Wireless Mobile Network (such as a Long-Term Evolution and 5G New Radio), a Wireless Fidelity (Wi-Fi) network, a Personal Area Network (PAN), a Local Area Network (LAN), or a Metropolitan Area Network (MAN). Various devices in the network environment 100 may be configured to connect to the communication network 112 in accordance with various wired communication protocols and wireless communication protocols. Examples of the wire and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The database 114 may include suitable logic, interfaces, and/or code that may be configured to store records of the requests for the vehicle charging service received from the set of vehicles 108A . . . 108N, the estimated demand for the vehicle charging service, and the determined selling price for the vehicle charging service. Each record may include timestamps associated with one or more of reception of the requests, estimation of the demand, or determination of the selling price for the vehicle charging service. The database 114 may be derived from data off a relational or non-relational database or a set of comma-separated values (csv) files stored on a conventional or a big-data storage. The database 114 may be stored or cached on a device, such as the server 110 (and one or more electronic devices of the set of electronic devices 102A . . . 102N). The operations of the database 114 may be executed using hardware such as a microprocessor (for example, to perform, or control performance of, one or more operations), a processor, an application-specific integrated circuit (ASIC), or a field-programmable gate array (FPGA). In some other instances, the database 114 may be implemented using software.

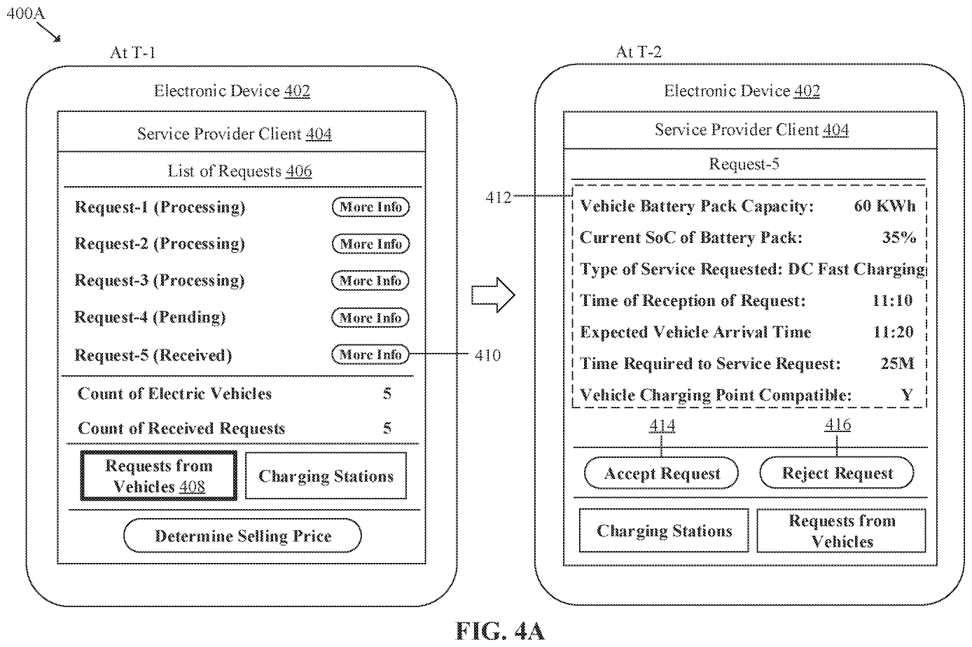

In operation, the electronic device 102A may receive, from a service provider associated with a charging station (for example, the charging station 104A), an input that includes a threshold selling price for offering of a vehicle charging service. The service provider may be an entity that renders the vehicle charging service. For example, the entity may include individual(s) such as homeowners who may have commercialized private charging station(s) at their residential locations or other non-residential locations to render the vehicle charging service. The electronic device 102A may be configured to execute a software or a web-based application to provide a platform for management of the charging station 104A. The service provider may register or login to a service provider account on the software or the web-based application to view or update information associated with a network of charging stations (including the charging station 104A). In accordance with an embodiment, the electronic device 102A may receive the input (i.e., the threshold selling price) from an owner (i.e., the service provider) of the charging station 104A. The owner may provide an input that indicates the threshold selling price for the vehicle charging service. The threshold selling price may a minimum service value that the owner of the charging station 104A may expect in exchange for rendering the vehicle charging service at the charging station 104A. As an example, the threshold selling price may be 5 United States Dollar per hour or 16 cents per unit of consumption. Details pertaining to the reception of the input that includes the threshold selling price is further provided, for example, in FIG. 3.

The electronic device 102A may further receive inputs associated with the charging station 104A. Such inputs may include a number of charging spots at the charging station 104A and a type of vehicle charging service (for example, trickle charge, AC charging, or DC charging) that may be offered by the charging station 104A.

Other electronic devices in the set of electronic devices 102A . . . 102N may be associated with respective service providers. For example, a service provider associated with the electronic device 102N may offer the vehicle charging service via the charging station 104N. Electronic devices associated with the service providers may exchange information between each other. For example, the information may be associated with active charging stations that operate in a geographical region. Each of the set of electronic devices 102A . . . 102N may store a list of active charging stations. Such a list may correspond to the set of charging stations 104A . . . 104N that operate in the geographical region. For example, the electronic device 102A may transmit information associated with the charging station 104A to the electronic device 102N and receive information associated with the charging station 104N from the electronic device 102N.

At any time-instant, the electronic device 102 may collect information that includes requests for the vehicle charging service. The requests may be received from the set of electric vehicles 108A . . . 108N in the geographical region. In accordance with an embodiment, the request may include a message with information that may be necessary to allocate or recommend a charging station to an electric vehicle.

In accordance with an embodiment, the information that includes the requests may be collected from datapoints related to a selection of active charging station(s) by users of at least a subset of the set of electric vehicles 108A . . . 108N. Additionally, or alternatively, the collection may be based on analysis of a click pattern on the map-based UI and/or search queries or inputs (from vehicle users) related to charging stations in the geographical region. The selection of an active charging station may be based on a geo-location of the electric vehicle and geo-locations corresponding to the set of charging stations 104A . . . 104N. For example, the geo-location of the charging station 104A may be within a preconfigured threshold distance from the electric vehicle and geo-location of the charging station 104A may be closest to the electric vehicle compared to the geo-locations of other charging stations that operate in the geographical region.

In accordance with an embodiment, the electronic device 102A may collect first information associated with each of the requests. The electronic device 102A may accept or reject the requests based on the first information. For a request, the corresponding first information may include, for example, a time of reception of the request, a type of vehicle charging service required (for example, DC fast charging) by the electric vehicle 108A, an expected time of arrival of the electric vehicle 108A at the charging station 104A, an expected time required to service the request, a specification of the electric vehicle 108A, an estimated time of arrival (ETA) to a nearest or a preferred charging station (from the set of charging stations 104A . . . 104N) in the geographical location, and the like. The specifications may include one or more of a type of charging port of the electric vehicle 108A, a current SOC of a battery pack of the electric vehicle 108A, a difference between a required SOC and the current SOC of the electric vehicle 108A, or a capacity of the battery pack of the electric vehicle 108A.

The type of vehicle charging service required by the electric vehicle 108A and the specifications of the electric vehicle 108A may be indicated in the received request. The electronic device 102A may estimate the expected time of arrival of the electric vehicle 108A at the charging station 104A based on respective geo-locations of the electric vehicle 108A and the charging station 104A, and a traffic density of electric vehicles in the geographical region. In an embodiment, the electronic device 102A may estimate the expected time to service the request based on the expected time of arrival of the electric vehicle 108A, the type of vehicle charging service required by the electric vehicle 108A, and the specifications (i.e., the current SOC and capacity of the battery pack of the electric vehicle 108A) of the electric vehicle 108A. The estimated may be further based on availability of a parking spot to use the charging station 104A.

Based on the type of vehicle charging service required and the specifications of the electric vehicle 108A, the electronic device 102A may accept or reject the request. For example, the request may be accepted if the charging station 104A includes at least one charging point that is compatible to the charging port of the electric vehicle 108A and the charging station 104A offers the type of vehicle charging service required by the electric vehicle 108A. The electronic device 102A may further accept or reject the request based on a count of requests received from the set of electric vehicles 108A . . . 108N, the expected time required to service each of the requests, and the time of reception of each of the first set of requests. The electronic device 102A may reject the request if the count of received requests exceeds a threshold count or the expected time required to service the received requests is more than a maximum waiting period. For example, the electronic device 102A may receive four requests from four electric vehicles. The request received from the electric vehicle 108A may be rejected if the request is received after reception of three requests (i.e., the threshold count of requests) and the expected time required to service the three requests is greater than 60 minutes (i.e., the maximum waiting period).

In accordance with an embodiment, the electronic device 102A may collect second information associated with each of the set of charging stations 104A . . . 104N (apart from the charging station 104A). The second information may include a number of charging spots at each charging station of the set of charging stations 104A . . . 104N, an average charging time for a full charge at each charging station of the set of charging stations 104A . . . 104N, or an availability of one or more charging spots within a defined duration at each charging station of the set of charging stations 104A . . . 104N.

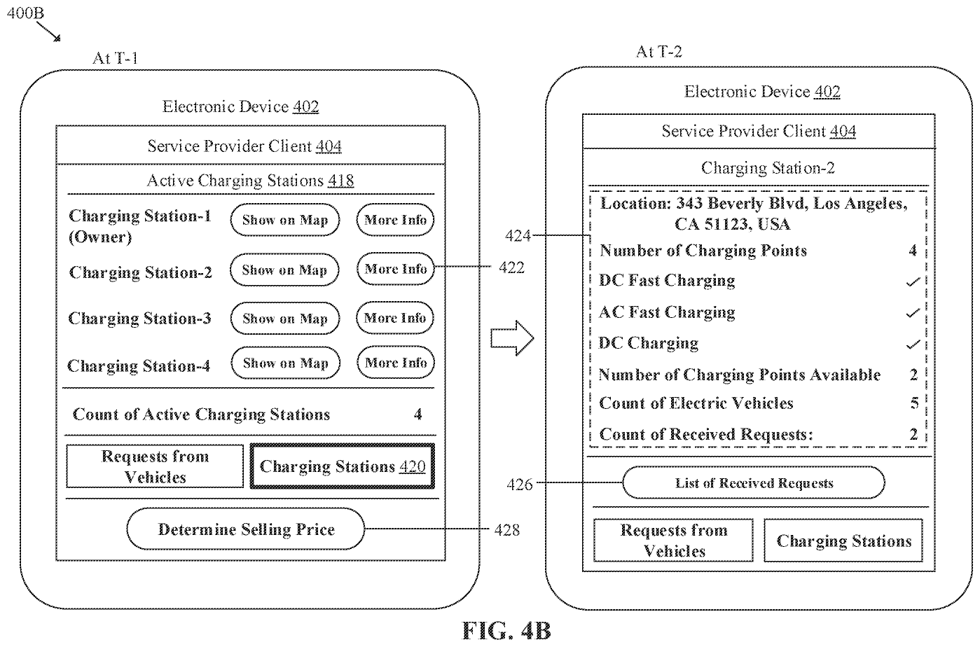

The electronic device 102A may receive the second information from other electronic devices of the set of electronic devices 102A . . . 102N. For example, the electronic device 102A may receive the second information associated with the charging station 104N from the electronic device 102N. The second information may indicate that the number of charging spots at the charging station 104N is four, the number of charging spots available at the charging station 104N is two, and the number of requests for the vehicle charging service at the charging station 104N is two. Details pertaining to the collection of information are further provided, for example, in FIG. 4A and FIG. 4B.

The electronic device 102 may estimate a demand for the vehicle charging service in the geographical region based on the collected information (i.e., the first information and the second information). In accordance with an embodiment, the electronic device 102A may determine a set of parameters that may affect the demand for the vehicle charging service. The demand may be estimated based on at least one parameter of the set of parameters. Such parameters may include, for example, a count of the set of charging stations 104A . . . 104N that operate in the geographical region, a count of the set of electric vehicles 108A . . . 108N that require the vehicle charging service in the geographical region, a count of the requests from the set of electric vehicles 108A . . . 108N, a traffic density of electric vehicles in the geographical region, a current SOC of each electric vehicle of the set of electric vehicles 108A . . . 108N, a time window for charging the set of electric vehicles 108A . . . 108N, and a capacity of a battery pack of each electric vehicle of the set of electric vehicles 108A . . . 108N. The electronic device 102A may use at least one of the first information or the second information for determination of at least one parameter of the set of parameters.

In accordance with an embodiment, the electronic device 102A may determine the count of charging stations in the set of charging stations 104A . . . 104N from the list of active charging stations that operate in the geographical region. For example, if the list of active charging stations includes four charging stations, then the count may be determined as four. Similarly, the count of electric vehicles may be determined based on the requests and the information associated with the requests.

The current SOC of each electric vehicle and the capacity of the battery pack of each electric vehicle may be determined based on the request received from the corresponding electric vehicle. The current SOC and the capacity of the battery pack of the electric vehicle may be indicated in the request received from the electric vehicle.

The time window for charging the set of electric vehicles 108A . . . 108N may be determined based on a time (e.g., an average or median time) required to service a request received from each electric vehicle and a time of reception of the request from each electric vehicle of the set of electric vehicles 108A . . . 108N. For example, the set of electric vehicles 108A . . . 108N may include three vehicles and a request may be received from each of the three electric vehicles. Thus, a total of three requests may be received. A first request may be received at 11:00, a second request may be received at 11:10, and a third request may be received at 11:15. The three requests may be serviced by three charging stations of the set of charging stations 104A . . . 104N. The time required to serve the first request may be 20 minutes (i.e., 11:00 to 11:20), the time required to serve the second request may be 25 minutes (i.e., 11:10 to 11:35), and the time required to serve the third request may be 20 minutes (i.e., 11:15 to 11:35). Thus, the time window for charging the set of electric vehicles 108A . . . 108N may be determined as 35 minutes (i.e., 11:00 to 11:35).

The traffic density of electric vehicles in the geographical region may be determined based on machine learning-based techniques (for example, decision tree, deep learning, or linear regression). The electronic device 102A may apply a machine learning model on traffic data (for example, a number of vehicles at road intersections in the geographical region, locations of the intersections, maximum and minimum speeds of the vehicles, an average speed of the vehicles, and so on). The data may be generated based on analysis of a set of image frames. The set of image frames may be obtained using sensors (for example, cameras at certain road location such as intersections or cameras on vehicle(s)).

Each parameter of the set of parameters may be indicative of a demand for the vehicle charging service in the geographical region. For example, an increase in the count of the set of charging stations 104A . . . 104N may decrease the demand. On the other hand, an increase in at least one of the count of the set of electric vehicles 108A . . . 108N, the count of the requests from the set of electric vehicles 108A . . . 108N, and the time window for charging the set of electric vehicles 108A . . . 108N may increase the demand. The electronic device 102A (associated with the charging station 104A) may quantize the demand based on the set of parameters. The set of parameters may act as inputs of a machine learning model. The electronic device 102A may apply the machine learning model on values of the set of parameters. The weights or coefficients of the machine learning model may be set (or adjusted) based on impact of each parameter on the demand for the vehicle charging service. The output of the machine learning model may be a quantized value that may reflect the demand for the vehicle charging service in the geographical region.

In accordance with an embodiment, the electronic device 102A may store the values of the set of parameters. The value of each parameter may be stored on the electronic device 102A or on the server 110. The value of each parameter of the set of parameters may be appended to a series of previously determined values of the same parameter. For example, at 11:00 AM, the electronic device 102A may determine a value of the count of electric vehicles that require the vehicle charging service. The value may be appended to a series of previously determined values of the count. Thus, a timeseries of values corresponding to each parameter may be generated. The timeseries of values for each parameter of the set of parameters may be stored as historical data. The electronic device 102A may retrieve (locally from the electronic device 102A) or receive (from the server 110) the historical data associated with each parameter that may affect the demand for the vehicle charging service. The historical data may be used to train a machine learning model and the timeseries of values may fed as an input to the machine learning model.

Once training of the machine learning model is complete, the electronic device 102A may use the trained first machine learning model to predict values of the set of parameters for a future time instant. The electronic device 102A may further estimate the demand for the vehicle charging service at the future time instant based on the values predicted by the machine learning model. For example, at 11:45, the model may predict values of the set of parameters at 12:15. Based on the predicted values, the electronic device 102A may estimate the demand for the vehicle charging service at 12:15. Details pertaining to the estimation of the demand for vehicle charging service are further provided, for example, in FIG. 4A and FIG. 4B.

Based on the estimated demand for the vehicle charging service, the electronic device 102A may further determine a selling price for the vehicle charging service. In accordance with an embodiment, the selling price for the vehicle charging service may be directly proportional to the demand for the vehicle charging service. For example, the selling price for the vehicle charging service may be determined as 25 cents (i.e., $0.25) per Kilo Watt hour. The electronic device 102A may transmit the determined value of the selling price for the vehicle charging service to other electronic devices (for example, the electronic device 102N) of the set of electronic devices 102A . . . 102N. It should be noted that other electronic devices may also determine and transmit respective estimates of the selling price for the vehicle charging service.

In accordance with an embodiment, the electronic device 102A may store the determined value of selling price on the electronic device 102A or on the server 110. The value of selling price may be stored along with previously determined values of selling price to generate historical price data. The electronic device 102A may use the historical price data to train a machine learning model. Once the training of the machine learning model is complete, the electronic device 102A may use the trained machine learning model to predict values of the set of parameters for a future time instant. Details pertaining to the determination of the selling price for the vehicle charging service are further provided, for example, in FIGS. 4A and 4B.

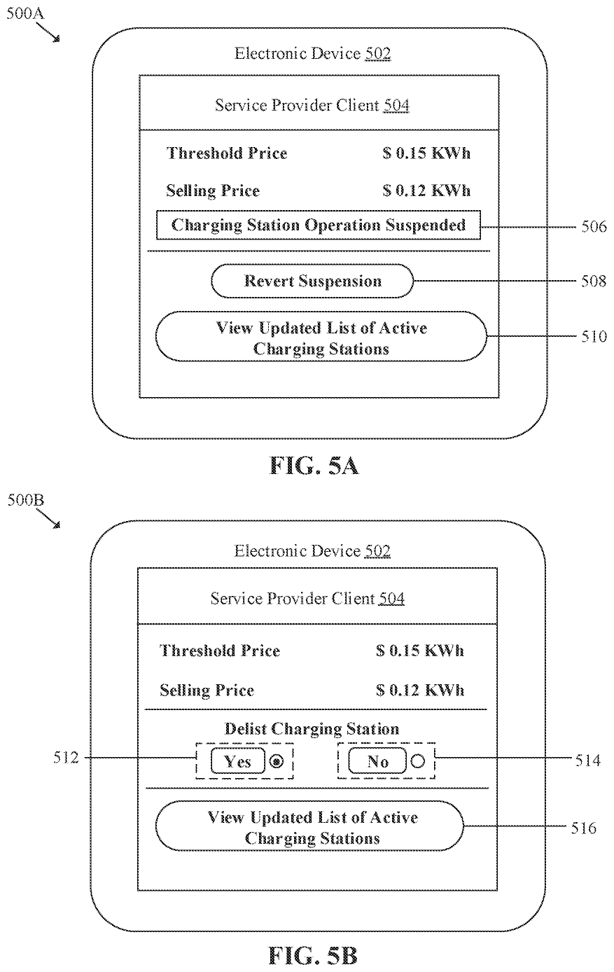

The electronic device 102A may update the list of active charging stations based on a comparison of the determined selling price with the threshold selling price. The list of active charging stations may include identifiers corresponding to the set of charging stations 104A . . . 104N. In accordance with an embodiment, the list of active charging stations may be updated by removing a record that corresponds to the charging station 104A. The removal may be performed based on a determination that the determined selling price is below the threshold selling price. The update may correspond to a removal of an active charging station (i.e., the charging station 104A) from the list of active charging stations that operate in the geographical region. The comparison may indicate that the selling price for the vehicle charging service (by the charging station 104A) is less than the threshold selling price (set by a service provider (e.g., owner) associated with the charging station 104A). If the selling price is less than the threshold selling price, then it may not be profitable and sustainable for the service provider keep on operating the charging station 104A and offer the vehicle charging service at the determined selling price. The removal from the list may be an indication to the service provider to stop offering the vehicle charging service at the charging station 104A. In some scenarios, other electronic devices (for example, the electronic device 102N) of the set of electronic devices 102A . . . 102N may also update the list of active charging stations. For example, the electronic device 102N may remove the charging station 104N from the list of active charging stations based on a comparison of the selling price (received from the electronic device 102A or determined by the electronic device 102N) for the vehicle charging service and a threshold selling price for the vehicle charging service (set by a service provider of the charging station 104N). Details pertaining to the updating of list of active charging stations are further provided, for example, in FIG. 5A and FIG. 5B.

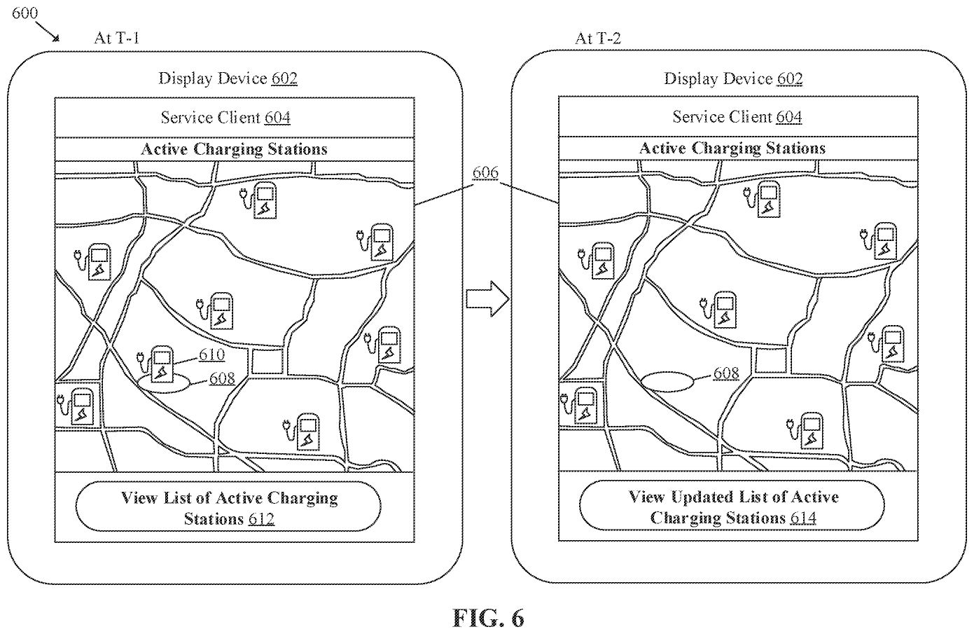

Based on the updated list of the active charging stations, the electronic device 102A may control a rendering of a map-based UI (shown in FIG. 6A and FIG. 6B) for the vehicle charging service on one or more display devices (i.e., the set of display devices 106A . . . 106N). The rendered map-based UI for the vehicle charging service may include an interactive map that indicates charging stations included in the updated list of the active charging stations. On the map-based UI, such stations may be rendered as UI elements that may be placed at respective locations in the map of the geographical region. Before the list of active charging stations is updated, all active charging stations in the list may be indicated on the map-based UI. In other words, the display devices may render the map-based UI to indicate the set of charging stations 104A . . . 104N. After the list of active charging stations is updated (i.e., after a removal of a record corresponding to the charging station 104A from the list), the electronic device 102A may control the rendering of the map-based UI on each display device of the set of display devices 106A . . . 106N to hide, remove, or disable a UI element that indicates a location of the charging station 104A on the map-based UI. The removal or disablement of the UI element may reduce the count of charging stations in the list of active charging stations. The reduction may enhance the demand per station for the vehicle charging service, which in turn, may lead to an increase in the selling price of the vehicle charging service. The electronic device 102A may monitor the increase in the selling price, and may determine, at each instance of the increase, whether the current selling price is greater than the threshold selling price. If the electronic device 102A determines that the current selling price is greater than the threshold selling price, the electronic device 102A may update the list of active charging stations. The update may include a record corresponding to the charging station 104A in the list of active charging stations. Based on the update, the electronic device 102A may control the rendering of the map-based UI on each display device of the set of display devices 106A . . . 106N to include or enable a UI element that indicates the location of the charging station 104A on the map-based UI.

In some scenarios, other electronic devices (for example, the electronic device 102N) of the set of electronic devices 102A . . . 102N may also control the rendering of the map-based UI to hide, remove, or disable UI elements indicative of locations of other charging stations (for example, the charging station 104N) of the set of charging stations 104A . . . 104N. Details pertaining to the rendering of the map-based UI are further provided, for example, in FIG. 6.

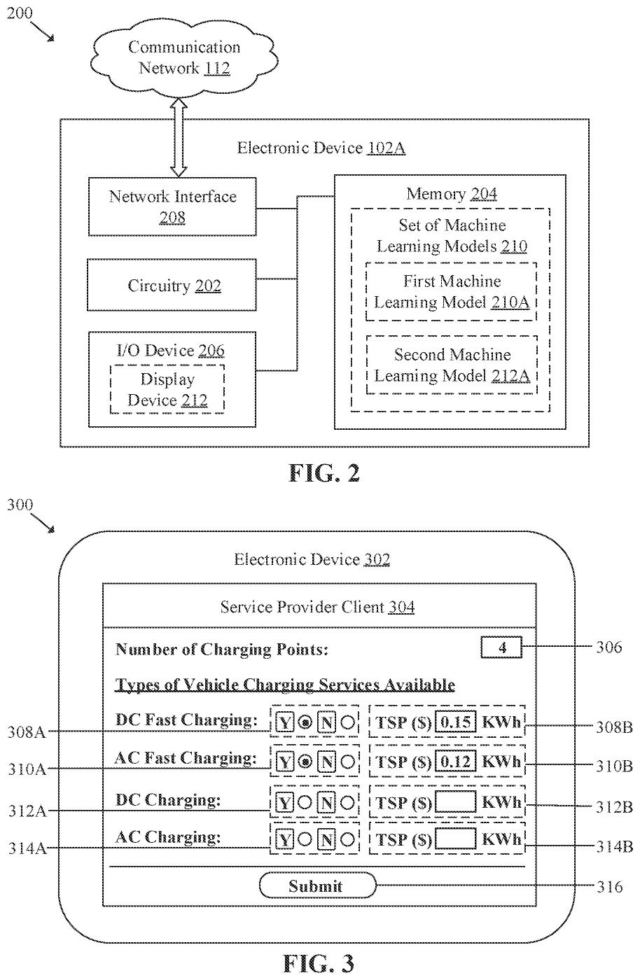

FIG. 2 is a block diagram that illustrates an exemplary electronic device that serves as a platform for management of vehicle-related services based on demand and profitability, in accordance with an embodiment of the disclosure. FIG. 2 is explained in conjunction with elements from FIG. 1. With reference to FIG. 2, there is shown a block diagram 200 of the electronic device 102A. The electronic device 102A may include circuitry 202, a memory 204, an input/output (I/O) device 206, and a network interface 208. The circuitry 202 may be communicatively coupled to the memory 204, the I/O device 206, and the network interface 208, through wired or wireless communication of the electronic device 102. In at least one embodiment, the memory 204 may store a set of machine learning models 210. In at least one embodiment, the I/O device 206 may include a display device 212.

The circuitry 202 may include suitable logic, circuitry, and/or interfaces that may be configured to execute program instructions associated with different operations to be executed by the electronic device 102A. The circuitry 202 may include any suitable special-purpose or general-purpose computer, computing entity, or processing device including various computer hardware or software modules and may be configured to execute instructions stored on any applicable computer-readable storage media. For example, the circuitry 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The circuitry 202 may include any number of processors configured to, individually or collectively, perform or direct performance of any number of operations of the electronic device 102A, as described in the present disclosure. Examples of the circuitry 202 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 204 may include suitable logic, circuitry, interfaces, and/or code that may be configured to store the set of instructions executable by the circuitry 202. In accordance with an embodiment, the memory 204 may include the database 114 (i.e., the records stored in the database 114). In accordance with an embodiment, the memory 204 may store a list of active charging stations. The active charging stations correspond to the set of charging stations 104A . . . 104N that operate in the geographical region. In accordance with an embodiment, the memory 204 may store information associated with each of the set of charging stations 104A . . . 104N and information associated with requests received by each of the set of electronic devices 102A . . . 102N from the set of electric vehicles 108A . . . 108N for the vehicle charging service. For example, the information associated with the charging station 104A may include number of charging spots at the charging station 104A, an average charging time for a full charge at the charging station 104A, or an availability of one or more charging points at the charging station 104A. The memory 204 may further store records of determined values of a set of parameters that may be used for estimation of the demand for the vehicle charging service, the estimated demand, and a selling price for offering of the vehicle charging service (determined based on the demand). Example implementations of the memory 204 may include, but may not be limited to, Random Access Memory (RAM), Read Only Memory (ROM), Hard Disk Drive (HDD), a Solid-State Drive (SSD), a CPU cache, and/or a Secure Digital (SD) card.

In accordance with an embodiment, the set of machine learning models 210 may include a first machine learning model 210A and a second machine learning model 2108. Each machine learning model of the set of machine learning models 210 may be a regression model or a classification model. The first machine learning model 210A may predict (i.e., forecast) a set of parameters that affect the demand for the vehicle charging service. The first machine learning model 210A may include data (e.g., weights or coefficients) and computer-executable code, that when executed, may enable a computing device such as the electronic device 102A to estimate the demand for the vehicle charging service based on predicted values of each of the set of parameters. The circuitry 202 may receive (from the server 110) or retrieve (from the memory 204) historical data associated with the set of parameters. The historical data may include a timeseries of values corresponding to each parameter of the set of parameters. The circuitry 202 may determine the values at each instance of estimation of the demand for the vehicle charging service. Once a value of a parameter is determined, the circuitry 202 append the determined value to a series of previously determined values of the parameter to prepare the timeseries of values corresponding to the parameter. Similarly, a timeseries of values corresponding to the other parameters of the set of parameters may be prepared to obtain the historical data.

The circuitry 202 may train the first machine learning model 210A on the historical data associated with the set of parameters. The training may include application of the first machine learning model 210A on the timeseries of values corresponding to each parameter of the set of parameters. The circuitry 202 may control the trained first machine learning model 210A to predict values of the set of parameters for a future time instant. The demand for the vehicle charging service may be estimated based on the predicted values.

The second machine learning model 210B may predict the selling price of the vehicle charging service. The second machine learning model 210B may include data (e.g., weights or coefficients) and computer-executable code, that when executed, may enable a computing device such as the electronic device 102A to determine a value of the selling price of the vehicle charging service for a future time instant. The determination may be based on historical price data for the set of charging stations 104A . . . 104N (that offer the vehicle charging service in the geographical region). The historical price data may include previously determined values of the selling price at which the set of charging stations 104A . . . 104N may have offered vehicle charging service in the past. The circuitry 202 may receive (from the server 110) or retrieve (from the memory 204) the historical price data and may train the second machine learning model 210B based on the historical price data. The trained second machine learning model 210B may predict the selling price of the vehicle charging service for a future time instant.

Each of the set of machine learning models 210 may include electronic data, which may be implemented as, for example, a software component of an application executable on the electronic device 102A. Each of the set of machine learning models 210 may rely on libraries, external scripts, or other logic/instructions for execution by a processing device, such as the circuitry 202. Additionally, or alternatively, each of the set of machine learning models 210 may be implemented using hardware including a processor, a microprocessor (e.g., to perform or control performance of one or more operations), a field-programmable gate array (FPGA), or an application-specific integrated circuit (ASIC). Alternatively, in some embodiments, each of the set of machine learning models 210 may be implemented using a combination of hardware and software. An example of the set of machine learning models 210 may include, but is not limited to, regression-based machine learning models that may be trained to forecast values of the set of parameters based on the historical data associated with the set of parameters and forecast the selling price based on the historical price data. Examples of the regression-based machine learning models may include, but is not limited to, a moving average, an exponential moving average (EMA), a linear regression, a multivariate regression, a logistic regression, a polynomial regression, a decision tree regression, and a gradient boosting regression.

In some embodiments, each of the set of machine learning models 210 may correspond to a learning engine that may execute numerical computation techniques using data flow graphs. In certain embodiments, the each of the set of machine learning models 210 may be based on a hybrid architecture of multiple models, such as artificial neural networks.

The I/O device 206 may include suitable logic, circuitry, interfaces, and/or code that may be configured to receive an input and provide an output based on the received input. The I/O device 206 may include one or more input and output devices that may communicate with different components of the electronic device 102A. For example, the I/O device 206 may receive an input that includes a threshold selling price for a vehicle charging service, type vehicle charging service (for example, AC first charging, DC fast charging, and so on) that may be offered by the charging station 104A, and number of charging spots in the charging station 104A via which the vehicle charging service may be offered. The I/O device 206 may further receive an input to render the list of active charging stations (i.e., the set of charging stations 104A . . . 104N) that offer the vehicle charging service in a geographical area, the information associated with each of the set of charging stations 104A . . . 104N, a set of requests for the vehicle charging service received by each of the set of charging stations 104A . . . 104N, information associated with requests for the vehicle charging service received from the set of electric vehicles 108A . . . 108N, and so on. The outputs provided by the I/O device 206, based on the received inputs, may be rendered on the display device 212. Examples of the I/O device 206 may include, but are not limited to, a touch screen, a keyboard, a mouse, a joystick, a microphone, and a speaker.

In some embodiments, the I/O device 206 may include the display device 212. The display device 212 may include suitable logic, circuitry, and interfaces that may be configured to receive inputs from the circuitry 202 to render, on a display screen, a list of active charging stations (i.e., the set of charging stations 104A . . . 104N) that operate in the geographical region, information associated with each of the set of charging stations 104A . . . 104N, information associated with requests received from the set of electric vehicles 108A . . . 108N (by the set of charging stations 104A . . . 104N) for the vehicle charging service, a set of parameters to be used for estimation of a demand for the vehicle charging service, a selling price for the vehicle charging service, and an updated list of active charging stations. In at least one embodiment, the display screen may be at least one of a resistive touch screen, a capacitive touch screen, or a thermal touch screen. The display device 212 or the display screen may be realized through several known technologies such as, but not limited to, at least one of a Liquid Crystal Display (LCD) display, a Light Emitting Diode (LED) display, a plasma display, or an Organic LED (OLED) display technology, or other display devices.

The network interface 208 may include suitable logic, circuitry, and interfaces that may be configured to facilitate communication between the circuitry 202, each of the other electronic devices (such as the electronic device 102N), each of the set of charging stations 104A . . . 104N, each of the set of display devices 106A . . . 106N, and the server 110, via the communication network 112. The network interface 208 may be implemented by use of various known technologies to support wired or wireless communication of the electronic device 102A with the communication network 112. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, a wireless pear-to-pear protocol, a protocol for email, instant messaging, and a Short Message Service (SMS).

The functions of the electronic device 102A or operations executed by the electronic device 102A, as described in FIG. 1, may be performed by the circuitry 202. Operations executed by the circuitry 202 are described in detail, for example, in the FIGS. 3, 4A, 4B, 5A, 5B, and 6.

FIG. 3 is an exemplary scenario diagram that illustrates a reception of a set of inputs that includes a threshold selling price for a vehicle charging service, in accordance with an embodiment of the disclosure. FIG. 3 is explained in conjunction with elements from FIG. 1 and FIG. 2. With reference to FIG. 3, there is shown an exemplary scenario diagram 300. In the exemplary scenario diagram 300, there is shown an electronic device 302 (for example, a smartphone). The electronic device 302 is an exemplary implementation of the electronic device 102A and functionality of the electronic device 302 may be identical to that of the electronic device 102A of FIG. 1. The electronic device 302 may be associated with the charging station 104A and may include a service provider client 304 (e.g., a web client or a software client) to represent a service provider account. The service provider client 304, when executed on the electronic device 302, may receive a set of inputs associated with a vehicle charging service (that may be offered using the charging station 104A).

At any time-instant, the circuitry 202 may receive the set of inputs from the service provider client 304. The set of inputs may correspond to user inputs received from a service provider (e.g., the owner) who may be associated with the charging station 104A. The circuitry 202 may execute the service provider client 304 to render UI elements on a display screen of the electronic device 302 for reception of the set of inputs. In accordance with an embodiment, the service provider client 304, when executed, may receive a user input via a user interface element 306 such as a textbox. The user input may indicate a number of charging spots (i.e., a number of parking spots that can accommodate and service the electric vehicles at a time) at the charging station 104A. By way of example, and not limitation, the received user input may indicate that the charging station 104A includes four charging spots and the four spots may accommodate four electric vehicles and all four vehicles may be charged at a time.

When executed on the electronic device 302, the service provider client 304 may further receive a user input that indicates whether a particular type of vehicle charging service is offered by the charging station 104A. In accordance with an embodiment, the service provider client 304 may render an option (to the owner of the charging station 104A) to indicate whether a particular type of vehicle charging service (for example, DC fast charging, AC fast charging, DC charging, or AC charging) is offered by the charging station 104A. The indication (i.e., a user input) may be received via a selection of at least one of user interface elements 308A, 310A, 312A, or 314A (for example, radio button). Each of such elements may correspond to a particular type of vehicle charging service. The circuitry 202 may determine that a particular type of vehicle charging service is offered by the charging station 104A based on a selection of a ‘yes’ option via the user interface elements 308A, 310A, 312A, or 314A. Similarly, the circuitry 202 may determine that the particular type of vehicle charging service is not offered by the charging station 104A based on a selection of a ‘no’ option via the user interface elements 308A, 310A, 312A, or 314A.

The service provider client 304 may further receive a user input that indicates a threshold selling price for a particular type of vehicle charging service. In some embodiments, the threshold selling price may be same for all types of vehicle charging service. As shown in FIG. 3, the service provider client 304 allows reception of a threshold selling price for each type of vehicle charging service. The user input that indicates the threshold selling price may be received via at least one of user interface elements 308B, 310B, 312B, or 314B (for example, a textbox). For example, the threshold selling price (“TSP”) for DC fast charging may be received as USD 0.15 (i.e., 15 cents) per kilo-Watt hour (kWh) via the user interface element 308B. The threshold selling price for DC fast charging may be received via a user interface element 308B (after a selection of the radio button that corresponds to the “yes” for DC fast charging). Similarly, threshold selling price for AC fast charging may be received as USD 0.12 per kWh via the user interface element 310B. The service provider client 304 may not enable the user elements 312B or 314B if there is no selection of the user interface elements 312A and 312A.

The service provider client 304 may further receive a user input via a user interface element 316 (for example, a radio button). Based on the reception of the user input via the user interface element 316, the electronic device 302 may receive a set of user inputs, viz., the number of charging spots at the charging station 104A, types of vehicle charging service offered by the charging station 104A, and a threshold selling price for each type of vehicle charging service offered by the charging station 104A. In accordance with an embodiment, the electronic device 302 may transmit the set of inputs to the devices associated with other charging stations of the set of charging stations 104A . . . 104N.

FIG. 4A is an exemplary scenario diagram that illustrates determination of a selling price for a vehicle charging service based on a demand for the vehicle charging service, in accordance with an embodiment of the disclosure. FIG. 4A is explained in conjunction with elements from FIG. 1, FIG. 2, and FIG. 3. With reference to FIG. 4A, there is shown an exemplary scenario 400A. The exemplary scenario 400A may include an electronic device 402 (for example, a smart phone). The electronic device 402 is an exemplary implementation of the electronic device 102A and functionality of the electronic device 402 may be identical to the electronic device 102A of FIG. 1. The electronic device 402 may be associated with the charging station 104A and may include a service provider client 404 (e.g., a web client or a software client) to represent a service provider account. The service provider client 404, when executed on the electronic device 402, may render requests received by the electronic device 402 from the set of electric vehicles 108A . . . 108N in the geographical region and information associated with the requests received from the set of electric vehicles 108A . . . 108N.

At T-1, the circuitry 202 may execute the service provider client 404 to render a list of requests 406. The list of requests 406 may be rendered on a user interface of the service provider client 404, based on reception of a user input via a user interface element 408 (for example, a radio button “Requests from Vehicles”). The list of requests 406 may include requests received for the vehicle charging service from certain electric vehicles of the set of electric vehicles 108A . . . 108N and a status of each of the requests. For example, the electronic device 402 may receive five requests from five electric vehicles that may require the vehicle charging service from the charging station 104A in next 30 minutes. Such requests may be received from, for example, respective display devices of the set of display devices 106A . . . 106N. For example, a user of an electric vehicle may use the display device to indicate a requirement of or an interest in the vehicle charging service. In order to estimate a demand for the vehicle charging service, the requirement or the interest may be treated as a request for the vehicle charging service. Alternatively, the user of the electric vehicle may use the display device to register for the vehicle charging service or book a charging spot at any specific charging station in a geographical region.

In accordance with an embodiment, the requests may be received based on a selection of a charging station such as the charging station 104A by the display devices of the electric vehicles. The charging station 104A may include three charging spots. Each spot may offer a different type of vehicle charging service or all three spots may offer a particular type of vehicle charging service. The status of three requests (viz., request-1, request-2, and request-3) may be indicated as “processing” (i.e., all three electric vehicles may be connected to respective connectors at the charging station 104A). The status of a request (i.e., request-4) may be “pending” as the three charging spots at the charging station 104A may be occupied by the three electric vehicles and the status of a request (i.e., request-5) may be indicated as “received”.

In accordance with an embodiment, the circuitry 202 may determine a count of electric vehicles that may have requested for the vehicle charging service from the charging station 104A and a count of the requests received from the electric vehicles. As shown, for example, the count of electric vehicles may be determined as “5” and the “count of requests received” may be determined as “5”. The circuitry 202 may control the service provider client 404 to render the count of electric vehicles and the count of requests received.

The circuitry 202 may further execute the service provider client 404 to render a user interface element (for example, a radio button “more info”) that corresponds to each of the received requests. Based on reception of a user input via a radio button “more info” for a received request (for example, request 5), the circuitry 202 may execute the service provider client 404 to render information associated with the received request. The information may include, for example, a type of vehicle charging service requested, a current SOC of a battery pack of the electric vehicle from which the request is received, and a battery capacity of the battery pack of the electric vehicle. The circuitry 202 may further determine a time of reception of the request, and one or more parameters based on the collected information and the time of reception of the request. The circuitry 202 may control the service provider client 404 to render the collected information associated with the request, the time of reception of the request, and the determined parameters.

At T-2, the circuitry 202 may control the service provider client 404 to render information 412 associated with request-5 based on reception of the user input 410 (i.e., the radio button “more info”) that corresponds to request-5. The information 412 may indicate that DC fast charging service is requested by an electric vehicle (for example, the electric vehicle 108A) from which request-5 is received, the current SOC of battery pack (at the time of reception of request-5) of the electric vehicle is 35%, and the capacity of the battery pack is 60 kWh. The information 412 may further indicate a time of reception of request-5, an expected time of arrival of the electric vehicle at the charging station 104A, an expected time to service (i.e., fully charge the battery pack of the electric vehicle) the request-5, and a compatibility of a charging port of the electric vehicle with connectors at the three charging spots of the charging station 104A. The expected time of arrival of the electric vehicle may be determined based on the time of reception of request-5 and a traffic density on one or more routes between the current geo-location of the electric vehicle and the charging station 104A. The expected time required to service request-5 may be determined based on the type of vehicle charging service (DC fast charging) requested by the electric vehicle, the current SOC of battery pack of the electric vehicle, and the capacity of the battery pack of the electric vehicle. Additionally, the expected time may be determined based on occupancy information about the charging spots for a period in which the electric vehicle may need the charging service.

In accordance with an embodiment, the circuitry 202 may control the service provider client 404 to render a user interface element 414 (for example, a radio button “accept”) and a user interface element 416 (for example, a radio button “reject”). The user interface element 414 may enable the service provider to accept or reject request-5. The status of request-5 in the list of requests 406 may be updated from “received” to “pending” if a user input indicates a selection of the radio button “accept” 414. On the other hand, the request-5 may be removed from the list of requests 406 if a user input indicates a selection of the radio button “reject” 416.

In accordance with an embodiment, the circuitry 202 may estimate a demand for the vehicle charging service based on the count of electric vehicles (e.g., 5), the count of requests received (e.g., 5), and the information associated with each of the requests 1-5. The information associated with each of the requests may include compatibility of vehicle charging ports of each of the 5 electric vehicles from which requests for the vehicle charging service are received, current SOC of battery pack of each of the 5 electric vehicles (at the time of reception of the requests from the 5 electric vehicles), battery capacity of battery packs of each of the 5 electric vehicles, time of reception of each of the 5 requests (i.e., request 1-5), time of arrival of each of the 5 electric vehicles (at the charging station 104A), and time required to service (i.e., fully charge the battery packs) each of the 5 requests.

FIG. 4B is an exemplary scenario diagram that illustrates determination of a selling price for a vehicle charging service based on a demand for the vehicle charging service, in accordance with an embodiment of the disclosure. FIG. 4B is explained in conjunction with elements from FIG. 1, FIG. 2, FIG. 3, and FIG. 4A. With reference to FIG. 4B, there is shown an exemplary scenario 400B. The exemplary scenario 400B may include the electronic device 402. The service provider client 404, included in the electronic device 402, may render a list of active charging stations 418 that operate in the geographical region and information associated with each charging station of the list of active charging stations 418. The circuitry 202 may estimate the demand and the selling price for the vehicle charging service based on information associated with requests for the vehicle charging service and the information associated with each charging station of the list of active charging stations 418.

At T-1, the circuitry 202 may control the service provider client 404 to render the list of active charging stations 418. The list of active charging stations 418 may be rendered based on reception of a user input via a user interface element 420 (for example, a radio button “Charging Stations”). For example, the list of active charging stations 418 (i.e., the set of charging stations 104A . . . 104N) may include 4 charging stations, viz., charging stations 1-4. The charging station-1 may correspond to the charging station 104A. The requests included in the list of requests 406 (see FIG. 4A) may be received based on selection of charging station-1 (i.e., the charging station 104A) by five electric vehicles (see FIG. 4A) of the set of electric vehicles 108A . . . 108N. Using the service provider client 404, the owner (i.e., service provider) of the charging station 104A may accept or reject the requests for the vehicle charging service. The charging station-1 may be associated with the electronic device 402 (i.e., the electronic device 102A).

In accordance with an embodiment, the circuitry 202 may determine a count of charging stations that operate in the geographical region from the list of active charging stations 418. The charging stations (i.e., charging stations 1-4) in the list of active charging stations 418 may correspond to the set of charging stations 104A . . . 104N. As shown, for example, the count of active charging stations may be determined as 4. The circuitry 202 may control the service provider client 404 to render the count of active charging stations.

The circuitry 202 may further control the service provider client 404 to render two user interface elements (for example, a radio button “show on map”, and a radio button “more info”) corresponding to each of the charging stations 1-4. Based on reception of a user input on the user interface element “show on map” for a charging station (for example, charging station-3), the circuitry 202 may control the service provider client 404 to render a map-based user interface to indicate a location of charging station-3 on a map of the geographical region. Similarly, reception of a user input on a user interface element “more info” for a charging station (for example, charging station-2), the circuitry 202 may control the service provider client 404 to render information associated with charging station-2. In accordance with an embodiment, the information associated with a charging station in the list of active charging stations 418 may include a location of the charging station, a number of charging spots at the charging station, types of vehicle charging service offered by the charging station, a number of charging spots available at the charging station, a count of electric vehicles that have requested the vehicle charging service from the charging station, and a count of requests received by an electronic device (for example, the electronic device 102N) associated with the charging station.

At T-2, the circuitry 202 may control the service provider client 404 to render information associated with charging station-2 based on reception of a user input via a user interface 422 (for example, the radio button “more info” 422). The service provider client 404 may render information 424 based on the reception of the user input. The information 424 may indicate that the location of charging station-2 is “Los Angeles”, the number of charging spots at charging station-2 is “4”, the types of vehicle charging service offered by charging station-2 are DC fast charging, AC fast charging, and DC charging (normal), the number of charging spots available at charging station-2 is “2” (i.e., 2 charging spots of charging station-2 are occupied), the count of electric vehicles that have requested the vehicle charging service from the charging station-2 is “2”, and the count of requests (for example request-1 and request-2) received by an electronic device associated with charging station-2 is “2”.

In accordance with an embodiment, the circuitry 202 may control the service provider client 404 to render a user interface element 426 (for example, a radio button “list of received requests”) that enables viewing of a list of requests. Based on reception of a user input via the user interface element 426, the circuitry 202 may control the service provider client 404 to render the list of requests. The requests included in the list of requests may be received by an electronic device of the set of electronic devices 102A . . . 102N that may be associated with the charging station-2. The circuitry 202 may collect information associated with each request that may be included in the list of requests.

In accordance with an embodiment, the circuitry 202 may estimate a demand for the vehicle charging service based on the count of active charging stations and the information associated with each of the charging stations 1-4 (for example, information 424 associated with charging station-2). The demand may be further estimated based on information associated with each request received by four electronic devices (of the set of electronic devices 102A . . . 102N) associated with the charging stations 1-4. The circuitry 202 may consolidate the information associated with the requests received by each of the four electronic devices to determine a set of parameters that may affect the demand for the vehicle charging service in the geographical region.

For example, the information associated with the requests 1-5 (see FIG. 4A) for the charging station-1 may be consolidated with information associated with requests 1 and 2 for the charging station-2, information associated with one or more requests for charging station-3, and information associated with the one or more requests for the charging station-4. The consolidation may be used to determine the set of parameters, viz., a count of the set of charging stations 104A . . . 104N that operate in the geographical region (i.e., “4”), a count of electric vehicles that require the vehicle charging service in the geographical region (i.e., “7” for charging stations-1 and 2), a count of the requests from the set of electric vehicles 108A . . . 108N (i.e., “7” for charging stations-1 and 2), a current SOC of each electric vehicle of the set of electric vehicles 108A . . . 108N, a capacity of a battery pack of each electric vehicle of the set of electric vehicles 108A . . . 108N, a time window for charging the set of electric vehicles 108A . . . 108N, and a list that maps the set of electric vehicles 108A . . . 108N with compatible charging connectors at charging stations-1-4.

In accordance with an embodiment, the circuitry 202 may determine the selling price for the vehicle charging service based on the estimated demand. The selling price may be determined based reception of a user input via a user interface 428 (for example, a radio button “determine selling price”).

FIG. 5A is an exemplary scenario diagram that illustrates update of a list of active charging stations based on a selling price for a vehicle charging service and a threshold selling price, in accordance with an embodiment of the disclosure. FIG. 5A is explained in conjunction with elements from FIG. 1, FIG. 2, FIG. 3, FIG. 4A and FIG. 4B. With reference to FIG. 5A, there is shown an exemplary scenario 500A. The exemplary scenario 500A may include an electronic device 502 (for example, a smart phone). The electronic device 502 may be an exemplary implementation of the electronic device 102A and functionality of the electronic device 502 may be identical to that of the electronic device 102A of FIG. 1. The electronic device 502 may be associated with the charging station 104A. The electronic device 502 may include a service provider client 504 (e.g., a software or a web client) for updating a list of active charging stations that operate in the geographical region. The list of active charging stations may be updated based on a comparison of a determined selling price for the vehicle charging service with a threshold selling price (set by the service provider (who may be owner) associated with the charging station 104A) for the vehicle charging service.

After the determination of the selling price for the vehicle charging service (based on the demand for the vehicle charging service), the circuitry 202 may compare the determined selling price with the threshold selling price. The selling price for the vehicle charging service may be determined by the electronic device 502 (i.e., the electronic device 102A) or other electronic devices of the set of electronic devices 102A . . . 102N. Based on the comparison, the circuitry 202 may update the list of active charging stations. In accordance with an embodiment, the list of active charging stations may be updated based on a removal of a record that corresponds to the charging station 104A from the list of active charging stations. The record may be removed based on a determination that the determined selling price is below the threshold selling price. The removal of the record may result in generation of an updated list of active charging stations. The removal of the record may be an indication to the service provider to suspend operations of the charging station 104A. The operations may be suspended since the determined selling price is less than the threshold selling price. The threshold selling price may be a minimum price at which it may be profitable for the service provider to offer the vehicle charging service via the charging station 104A.

In accordance with an embodiment, the circuitry 202 may control the service provider client 504 to render on a display screen of the electronic device 502, the threshold selling price (for example, 15 cents or USD 0.15 per kWh), the determined selling price (for example, 12 cents or USD 0.12 per kWh), and a message 506 that may indicate a suspension of operations of the charging station 104A. The circuitry 202 may control the service provider client 504 to render a user interface element 508 (for example, a radio button “revert suspension”) to revert the suspension of operations of the charging station 104A, and a user interface element 510 (for example, a radio button “view updated list of active charging stations”) to view the updated list of active charging stations.

FIG. 5B is an exemplary scenario diagram that illustrates rendering of an option to update a list of active charging stations, in accordance with an embodiment of the disclosure. FIG. 5B is explained in conjunction with elements from FIG. 1, FIG. 2, FIG. 3, FIG. 4A, FIG. 4B, and FIG. 5A. With reference to FIG. 5B, there is shown an exemplary scenario 500B. The exemplary scenario 500B may include the electronic device 502. The service provider client 504 may render an option to update a list of active charging stations based on the comparison of the determined selling price with the threshold selling price.

In accordance with an embodiment, the circuitry 202 may control the display device 212 (i.e., the display screen of the electronic device 502) to render an option (for example, a radio button “yes” 512 and a radio button “no” 514) to delist the charging station 104A from the list of active charging stations. The option may be rendered based on the comparison of the determined selling price with the threshold selling price.

The circuitry 202 may update the list of active charging stations based on a selection of the option (i.e., a reception of a user input via the radio button “yes” 512 or the radio button “no” 514). During the update, the circuitry 202 may remove a record corresponding to the charging station 104A from the list of active charging stations based on a user input via the radio button “yes” 512.

FIG. 6 is an exemplary scenario diagram that illustrates rendering of a map-based user interface for a vehicle charging service on a display device, in accordance with an embodiment of the disclosure. FIG. 6 is explained in conjunction with elements from FIG. 1, FIG. 2, FIG. 3, FIG. 4A, FIG. 4B, FIG. 5A, and FIG. 5B. With reference to FIG. 6, there is shown an exemplary scenario 600. The exemplary scenario 600 may include a display device 602. The functionality of the display device 602 may be identical to a display device of the set of display devices 106A . . . 106N shown in FIG. 1. The display device 602 may be associated with an electric vehicle of the set of electric vehicles 108A . . . 108N. The display device 602 may include a service client 604 (e.g., a web client or a software). The circuitry 202 may control the service client 604 to render a map-based user interface. The rendering may be performed based on data collected from a web-based mapping platform or a mapping application included in the display device 602.

At T-1, the circuitry 202 may control the service client 604 to render a map of a geographical region 606. The map-based user interface may indicate the location of each charging station from the list of active charging stations (i.e., the set of charging stations 104A . . . 104N) that operates in the geographical region 606. For, example, a location 608 of the geographical region 606 may correspond to the geo-location of the charging station 104A. The circuitry 202 may control the service client 604 to render a user interface element 610 to indicate presence of the charging station 104A at the location 608. The user interface element 610 may, thus, correspond to the charging station 104A. The circuitry 202 may control the service client 604 to also render a user interface element 612 (for example, a radio button “view list of active charging stations”). The service client 604 may render a list of active charging stations based on reception of a user input via the user interface element 612.

Based on an update of the list of active charging stations, the circuitry 202 may control the rendering of the map-based UI. The update may correspond to a removal of a record from the list of active charging stations. The record may correspond to the charging station 104A, for example. The rendering of the map-based UI may be controlled to hide, remove, or disable the user interface element 610 that indicates the geo-location (i.e., the location 608 of the geographical region 606) of the charging station 104A on the map-based UI.

At T-2, the user interface element 610 may be hidden or removed from the location 608. This may indicate (to a driver of the electric vehicle associated with the display device 602 or a user of the display device 602) that the charging station 104A is not non-operational in the geographical region 606.

In accordance with an embodiment, the circuitry 202 may control the service client 604 to render a user interface element 614 (for example, a radio button “view updated list of active charging stations”). The service client 604 may render an updated list of active charging stations based on reception of a user input via the user interface element 614.

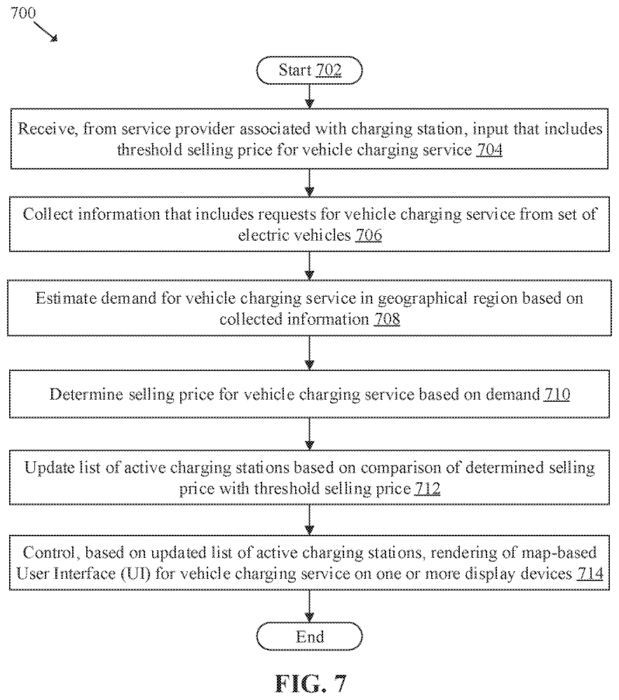

FIG. 7 is a flowchart that illustrates exemplary operations for management of vehicle-related services based on demand and profitability via a platform in an electronic device, in accordance with an embodiment of the disclosure. With reference to FIG. 7, there is shown a flowchart 700. The flowchart 700 is described in conjunction with elements from FIG. 1, FIG. 2, FIG. 3, FIG. 4A, FIG. 4B, FIG. 5A, FIG. 5B, and FIG. 6. The operations from 702 to 716 may be implemented, for example, by the electronic device 102A of FIG. 1 or the circuitry 202 of FIG. 2. The operations of the flowchart 700 may start at 702 and proceed to 704.

At 704, an input, that includes a threshold selling price for a vehicle charging service, may be received from a service provider associated with a charging station 104A. In at least one embodiment, the circuitry 202 may receive, from the service provider associated with the charging station 104A, the input that includes the threshold selling price for the vehicle charging service. Details about the reception of the threshold selling price are described, for example, in FIG. 1 and FIG. 3.

At 706, information, that includes requests for the vehicle charging service from a set of electric vehicles 108A . . . 108N, may be collected. In at least one embodiment, the circuitry 202 may collect information that includes requests for the vehicle charging service from a set of electric vehicles 108A . . . 108N. Details about collection of the information that includes the requests for the vehicle charging service are described, for example, in FIG. 1, FIG. 4A, and FIG. 4B.

At 708, a demand for the vehicle charging service in a geographical region may be estimated based on the collected information. In at least one embodiment, the circuitry 202 may estimate the demand for the vehicle charging service in the geographical region based on the collected information. The electronic device 102A may store a list of active charging stations in the memory 204. The list of active charging stations may correspond to the set of charging stations 104A . . . 104N that operate in the geographical region. The set of charging stations 104A . . . 104N may include the charging station 104A associated with the service provider. Details about estimation of the demand for the vehicle charging service in the geographical region are described, for example, in FIG. 1, FIG. 4A, and FIG. 4B.

At 710, a selling price for the vehicle charging service may be determined based on the demand. In at least one embodiment, the circuitry 202 may determine the selling price for the vehicle charging service based on the demand. Details about determination of the selling price for the vehicle charging service are described, for example, in FIG. 1, FIG. 4A, and FIG. 4B.

At 712, the list of active charging stations may be updated based on a comparison of the determined selling price with the threshold selling price. In at least one embodiment, the circuitry 202 may update the list of active charging stations based on the comparison of the determined selling price with the threshold selling price. Details about updating of the list of active charging stations are described, for example, in FIG. 1 and FIG. 5.

At 714, rendering of a map-based UI for the vehicle charging service on the set of display devices 106A . . . 106N may be controlled based on the updated list of active charging stations. In at least one embodiment, the circuitry 202 may control, based on the updated list of active charging stations, rendering of the map-based UI for the vehicle charging service on the set of display devices 106A . . . 106N. Details about control of the rendering of the map-based UI for the vehicle charging service are described, for example, in FIG. 1 and FIG. 6. Control may pass to the end.

Although the flowchart 700 is illustrated as discrete operations, such as 704, 706, 708, 710, 712, and 714, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as the electronic device 102A) for management of vehicle-related services at a charging station (such as the charging station 104A) based on demand and profitability via a platform included in the electronic device 102A. The set of instructions may be executable by the machine and/or the computer to perform operations that may include reception, from a service provider associated with a charging station 104A, an input that includes a threshold selling price for a vehicle charging service. The operations may further include collection of information that includes requests for the vehicle charging service from a set of electric vehicles 108A . . . 108N. The operations may further include estimation of a demand for the vehicle charging service in a geographical region based on the collected information. A list of active charging stations stored in a memory (such as the memory 204) of the electronic device 102A may correspond to a set of charging stations 104A . . . 104N that operate in the geographical region. The set of charging stations 104A . . . 104N may include the charging station 104A associated with the service provider. The operations may further include determination of a selling price for the vehicle charging service based on the demand. The operations may further include updating of the list of active charging stations based on a comparison of the determined selling price with the threshold selling price. The operations may further include control, based on the updated list of active charging stations, of rendering of a map-based UI for the vehicle charging service on a set of display devices.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

What is claimed is:

1. An electronic device, comprising:
a memory that stores a list of active charging stations; and
circuitry that:
receives, from a service provider associated with a charging station, an input that includes a threshold selling price for a vehicle charging service;
collects information that includes requests for the vehicle charging service from a set of electric vehicles;
estimates a demand for the vehicle charging service in a geographical region based on the collected information,
wherein the list of active charging stations corresponds to a plurality of charging stations that operate in the geographical region, and
the plurality of charging stations includes the charging station associated with the service provider;
determines a selling price for the vehicle charging service based on the demand;
updates the list of active charging stations based on a comparison of the determined selling price with the threshold selling price; and
controls, based on the updated list of active charging stations, rendering of a map-based User Interface (UI) for the vehicle charging service on one or more display devices.

2. The electronic device according to claim 1, wherein the collected information further includes at least one of:
a number of charging spots at each charging station of the plurality of charging stations,
an average charging time for a full charge at each charging station of the plurality of charging stations, or
an availability of one or more charging points at each charging station of the plurality of charging stations within a defined duration.

3. The electronic device according to claim 1, wherein the circuitry generates a list that maps the set of electric vehicles with compatible charging points at the plurality of charging stations, and the demand is estimated further based on the generated list.

4. The electronic device according to claim 1, wherein the demand is estimated further based on a set of parameters that include at least one of:
a count of the plurality of charging stations that operate in the geographical region,
a count of the set of electric vehicles that require the vehicle charging service in the geographical region,
a traffic density of electric vehicles in the geographical region,
a count of the requests from the set of electric vehicles,
a current State of Charge (SOC) of each electric vehicle of the set of electric vehicles,
a time window for charging the set of electric vehicles, or
a capacity of a battery pack of each vehicle of the set of electric vehicles.

5. The electronic device according to claim 1, wherein the circuitry further:
receives historical data associated with a set of parameters that affect the demand, wherein the historical data includes a timeseries of values corresponding to each parameter of the set of parameters;
trains a first machine learning model on the historical data; and
predicts values of the set of parameters for a future time instant by using the trained first machine learning model,
wherein the demand is estimated further based on the predicted values.

6. The electronic device according to claim 1, wherein the circuitry further:
receives historical price data for the plurality of charging stations that offer the vehicle charging service in the geographical region;
trains a second machine learning model on the historical price data; and
predicts the selling price of the vehicle charging service for a future time instant by using the trained second machine learning model.

7. The electronic device according to claim 1, wherein the list of active charging stations is updated by removing a record corresponding to the charging station, and the record is removed based on a determination that the determined selling price is below the threshold selling price.

8. The electronic device according to claim 1, wherein the rendering of the map-based UI is controlled to hide, remove, or disable a UI element that indicates a location of the charging station on the map-based UI.

9. The electronic device according to claim 8, wherein the UI element corresponds to the charging station for which a record from the list of active charging stations is removed after the update of the list of active charging stations.

10. The electronic device according to claim 1, further comprising a display device, wherein the circuitry further controls the display device to render, based on the comparison, an option to delist the charging station from the list of active charging stations, and
wherein the list of active charging stations is updated further based on a selection of the option.

11. A method, comprising:
in an electronic device that includes a memory for storing a list of active charging stations:
receiving, from a service provider associated with a charging station, an input that includes a threshold selling price for a vehicle charging service;
collecting information that includes requests for the vehicle charging service from a set of electric vehicles;
estimating a demand for the vehicle charging service in a geographical region based on the collected information,
wherein the list of active charging stations corresponds to a plurality of charging stations that operate in the geographical region, and
the plurality of charging stations includes the charging station associated with the service provider;
determining a selling price for the vehicle charging service based on the demand;
updating the list of active charging stations based on a comparison of the determined selling price with the threshold selling price; and
controlling, based on the updated list of active charging stations, a rendering of a map-based User Interface (UI) for the vehicle charging service on one or more display devices.

12. The method according to claim 11, wherein the collected information further includes at least one of:
a number of charging spots at each charging station of the plurality of charging stations,
an average charging time for a full charge at each charging station of the plurality of charging stations, or
an availability of one or more charging points at each charging station of the plurality of charging stations within a defined duration.

13. The method according to claim 11, further comprising generating a list that maps the set of electric vehicles with compatible charging points at the plurality of charging stations, wherein the demand is estimated further based on the generated list.

14. The method according to claim 11, wherein the demand is estimated further based on a set of parameters that include at least one of:
a count of the plurality of charging stations that operate in the geographical region,
a count of the set of electric vehicles that require the vehicle charging service in the geographical region,
a traffic density of electric vehicles in the geographical region,
a count of the requests from the set of electric vehicles,
a current State of Charge (SOC) of each electric vehicle of the set of electric vehicles,
a time window for charging the set of electric vehicles, or
a capacity of a battery pack of each vehicle of the set of electric vehicles.

15. The method according to claim 11, further comprising:
receiving historical data associated with a set of parameters that affect the demand, wherein the historical data includes a timeseries of values corresponding to each parameter of the set of parameters;
training a first machine learning model on the historical data; and
predicting values of the set of parameters for a future time instant by using the trained first machine learning model,
wherein the demand is estimated further based on the predicted values.

16. The method according to claim 11, further comprising:
receiving historical price data for the plurality of charging stations that offer the vehicle charging service in the geographical region;
training a second machine learning model on the historical price data; and
predicting the selling price of the vehicle charging service for a future time instant by using the trained second machine learning model.

17. The method according to claim 11, wherein the list of active charging stations is updated by removing a record corresponding to the charging station, and the record is removed based on a determination that the determined selling price is below the threshold selling price.

18. The method according to claim 11, wherein the rendering of the map-based UI is controlled to hide, remove, or disable a UI element that indicates a location of the charging station on the map-based UI.

19. The method according to claim 18, wherein the UI element corresponds to the charging station for which a record from the list of active charging stations is removed after the update of the list of active charging stations.

20. A non-transitory computer-readable medium having stored thereon computer implemented instructions that, when executed by an electronic device, causes the electronic device to execute operations, the operations comprising:
retrieving a list of active charging stations;
receiving, from a service provider associated with a charging station, an input that includes a threshold selling price for a vehicle charging service;
collecting information that includes requests for the vehicle charging service from a set of electric vehicles;
estimating a demand for the vehicle charging service in a geographical region based on the collected information,
wherein the list of active charging stations corresponds to a plurality of charging stations that operate in the geographical region, and
the plurality of charging stations includes the charging station associated with the service provider;
determining a selling price for the vehicle charging service based on the demand;
updating a list of active charging stations based on a comparison of the determined selling price with the threshold selling price; and
controlling, based on the updated list of active charging stations, rendering of a map-based User Interface (UI) for the vehicle charging service on one or more display devices.
